(19) United States
(12) Patent Application Publication
(10) Pub. No.: US 2007/0285701 A1
(43) Pub. Date: Dec. 13, 2007

(54) JOB STATUS NOTIFYING IMAGE FORMING APPARATUS

(76) Inventors: Yoshihide Ohta, Sagamihara-shi (JP); Hiroshi Fujiwara, Ikeda-shi (JP); Yasuhide Ohkubo, Toyonaka-shi (JP); Shigeo Nanno, Nishikyo-ku (JP); Yoshinobu Hada, Takarazuka-shi (JP); Ippei Kimura, Ikeda-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/758,311

(22) Filed: Jun. 5, 2007

(30) Foreign Application Priority Data
Jun. 9, 2006 (JP) 2006-160681

(51) Int. Cl. G06K 15/00

(52) U.S. Cl. 358/1.14

(57) ABSTRACT

An image forming apparatus includes a detecting device that detects an job progressing status of the image forming apparatus, a transmission device that receives from the detecting device and transmits the information of the job progressing status, and an information notifying device that receives from the transmission device and notifies a mobile phone of the job progressing status. The information notifying device is detachable from the image forming apparatus.

### CROSS REFERENCE TO RELATED APPLICATION

This application claims priority under 35 USC § 119 to Japanese Patent Application No. 2006-160681, filed on Jun. 9, 2006, the entire contents of which are herein incorporated by reference.

### BACKGROUND OF THE INVENTION

1. Field of the Invention

The present invention generally relates to an image forming apparatus, and in particular to a printing system, such as a laser printer, an ink jet printer, etc., using an electro-photographic system.

2. Discussion of the Background Art

It sometimes is difficult for a user to recognize an end of a job, such as facsimile reception, voluminous copying, etc., performed in an image forming apparatus having a facsimile or a copier function. Thus, the user needs to approach the image forming apparatus and to check the status of the job several times. It is a serious problem for a user who attempts to efficiently promote an operation that he or she is not notified that an error occurs or the apparatus is not available or busy and thus the job is not completed. Further, as a machine size decreases in a recently spreading multipurpose copier, in which a sheet is ejected inside, it is difficult to recognize ejection of the sheet.

Then, the Japanese Patent Application Laid Open No. 2003-127510 attempts to resolve such problems with a technology in that a light emission device is provided on the uppermost portion of an apparatus to indicate a job status remotely monitored. However, when the apparatus turns its back or is disposed under a desk, the job status can't be remotely viewed sometimes.

Further, the Japanese Patent Application Laid Open No. 2005-96130 discusses a method for notifying an apparatus status using a various sounds. However, a job status remains unknown when an apparatus is arranged in another room or an operator moves away from the apparatus.

Further, the Japanese Patent Registration No. 3715304 discusses a method for transmitting a facsimile promptly to a recipient, such as a business person who changes location frequently, etc. Specifically, image information is transmitted to a widely spreading mobile instrument these days capable of accessing a data retention server in which data is temporarily retained. A prescribed image forming apparatus receives the image information from the data retention server and starts image formation upon an instruction from the mobile instrument. Thus, the image information can be outputted regardless of the location of the business person.

However, since a digital image forming apparatus is generally arranged in an office, and accordingly, an electric wave sometimes is in a bad condition. Further, since the image information is generally voluminous, information transmission through a wireless device takes long time.

### SUMMARY OF THE INVENTION

The present invention has been made in view of the above noted and another problems and one object of the present invention is to provide a new and noble image forming apparatus.

Such a new and noble image forming apparatus includes a detecting device that detects an job progressing status of the image forming apparatus, a transmission device that receives from the detecting device and transmits the information of the job progressing status, and an information notifying device that receives from the transmission device and notifies a mobile phone of the job progressing status. The information notifying device is detachable from the image forming apparatus.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates an exemplary digital multi function machine including functions of a printer, a copier, a scanner, and a facsimile or the like;

FIG. 2 illustrates an exemplary system in which the digital multi function machine is commonly used by a plurality of users (mobile instruments);

FIG. 3 illustrates another exemplary system in which the digital multi function machine is commonly used by a plurality of users;

FIG. 4 illustrates another a digital multi function machine including functions of a printer, a copier, a scanner, and a facsimile or the like;

FIG. 5 illustrates an exemplary system in which an operator uses the digital multi function machine and makes copies;

FIG. 6 illustrates an exemplary system in which an operator keeps a notifying device;

FIG. 7 illustrates an exemplary system in which a digital multi function machine is connected to the network;

FIG. 8 illustrates an exemplary screen indicating print related instructions; and

FIG. 9 illustrates still another exemplary system in which the digital multi function machine is commonly used by a plurality of users.

### PREFERRED EMBODIMENTS OF THE PRESENT INVENTION

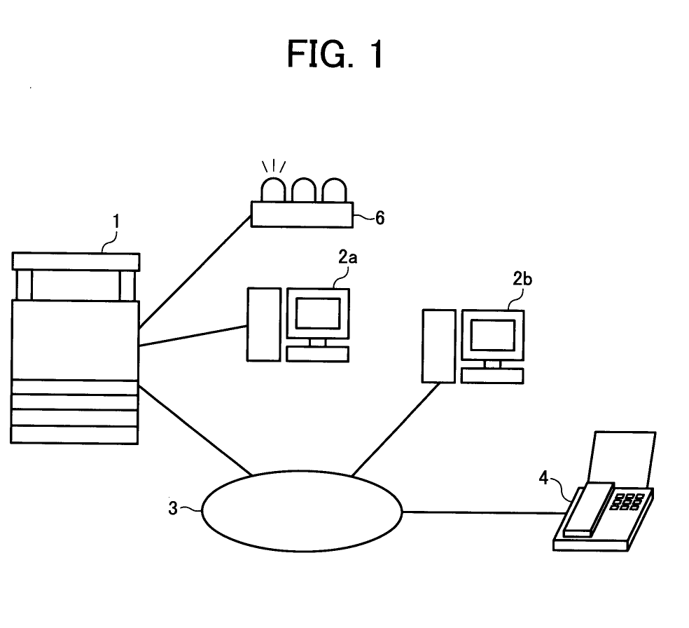

Referring now to the drawings, wherein like reference numerals and marks designate identical or corresponding parts throughout several figures, in particular in FIG. 1, an exemplary digital multi function machine (e.g. an image forming apparatus) 1 is described. As shown, the digital multi function machine 1 is connected directly to a personal computer (pc) 2a. The digital multi function machine 1 is connected to the pc 2b via a high-speed connection line or a telephone line 3 using a wired LAN cable or a modular cable. Thus, the pc 2b is enabled to remotely execute printing and scanning in the digital multi function machine 1. The digital multi function machine 1 communicates a facsimile with a facsimile apparatus 4 via the high-speed connection line or telephone line 3.

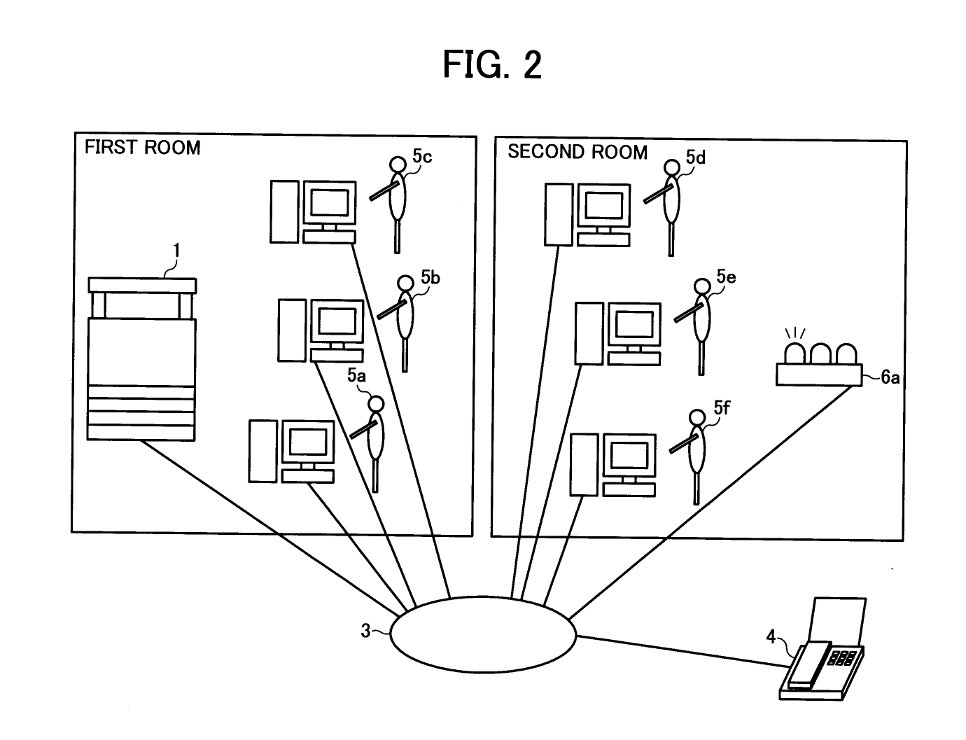

As shown in FIG. 2, the digital multi function machine 1 is generally difficult to be arranged near all users and viewable therefrom. Thus, when a large quantity of copy operations is executed, a user needs to approach the digital multi function machine 1 to check if a copying operation previously requested is completed. As a result, needless time is spent unconsciously thereby largely decreasing in labor efficiency. Especially, it is serious when an error occurs in the course. Thus, a function of remotely checking a status of the digital multi function machine 1 is needed. Then, a light emission device (not shown) is arranged at the topmost portion of the digital multi function machine 1 so that a job status can be remotely monitored. However, it is difficult to check the status when users 5d to 5f use the digital multi function machine 1 in the other office.

Then, according to one embodiment of the present invention, a notifying device 6a is disposed at a location where the users 5d to 5f can readily recognize. The notifying device 6 or 6a (herein after simply referred to as a notifying device 6) includes and turns on a LED light of a less power consumption type having long life. A blue light represents a status of absence of a job or ready for a new job because of completion of a previous job. A red light represents that a new job is unavailable due to occurrence of an error and accordingly interruption of a previous job. A green light notifies reception of a facsimile. Thus, the remote user 5 can recognize if the large quantity of copies is safely completed and a facsimile is received. Further, blinking of the blue represents that the digital multi function machine 1 is in the course of a job.

Fast speed blinking represents that a lot of job remains uncompleted. A blinking speed of the green light represents that a great number of facsimiles are received. Thus, such blinking represents a lot of information. The notifying device 6 returns to the turn on condition when a copying or printing job instructed by the user 5 is completed.

Since removal of a reception facsimile needs to be reported to a user in practical use, a prescribed command is inputted when a notification cancellation button (not shown) provided on the digital multi function machine 1 is depressed for the purpose of canceling transmission of status notification.

However, a special tray other than the reception tray can be separately equipped for the facsimile apparatus 4 as a cancellation system not to over look cancellation. Specifically, an instruction for stopping notification is most preferably outputted by detecting a sheet disappearing from the facsimile reception tray using a sensor. A manner of notification by means of the notification device 6 is optionally employed in accordance with environment of the user 5. For example, when the digital multi function machine land notifying device 6 are used in the office having a blind corner due to a complicated layout, the notification is preferably executed by sound. Further, the notification manner is preferably changed in accordance with an instruction from the digital multi function machine 1. Thus, a status of the apparatus can be readily recognized even when many obstacles interfere field of vision.

As a connection manner for connecting the notifying device 6 to the digital multi function machine 1, direct connection using a wired device, such as a LAN, a USG, etc., improves credibility of information transmission and is not costly.

Further, when connection is made using a short distance wireless system, such as a wireless LAN, a Bluetooth, etc., a freedom level of installation is improved.

Thus, the notifying device 6 can optionally be located by a user, such as on a table or a wall. By arranging the notifying device 6 at a location where the user 5 frequently looks over or passes through, completion of the large quantity of copies and reception of a facsimile can be quickly recognized.

Further, an optimal location for arranging such a notifying device 6 changes in accordance with a change in usage environment of the user 5. Thus, an office space can be efficiently used when the notifying device 6 becomes useless and is installed in the body of the digital multi function machine 1.

Further, a freedom level of a usage manner is improved for the user 5.

Further, the notifying device 6 can selectively be installed either in the body not to consume a space or is arranged at a location where the notifying device 6 is readily recognized in accordance with an office layout of the user 5.

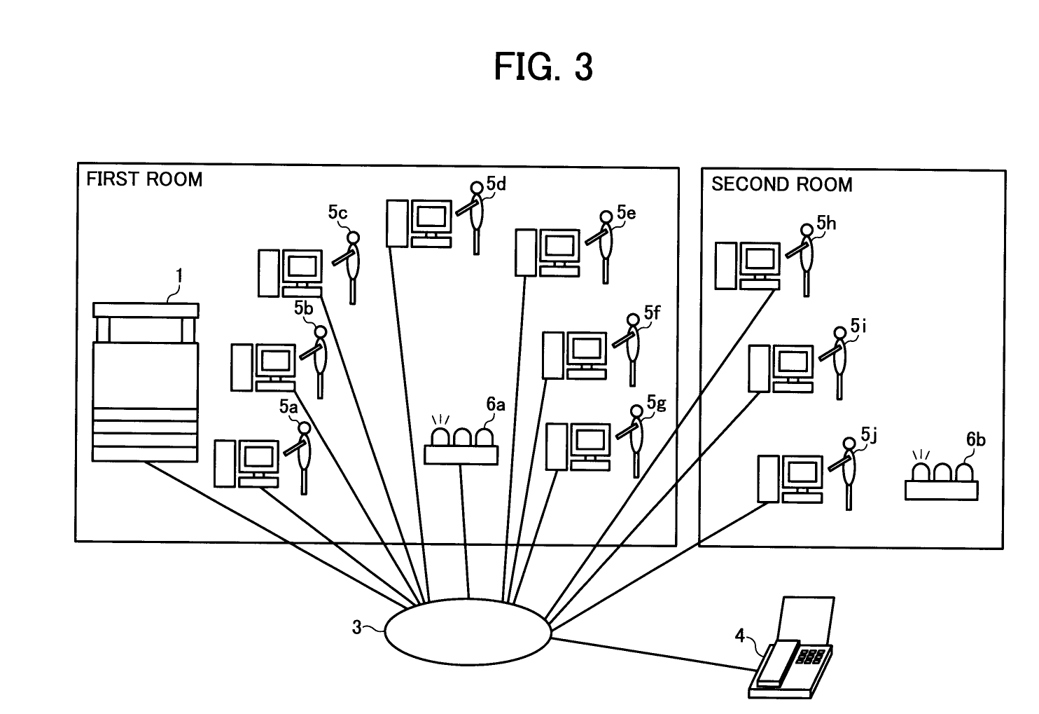

Now, another exemplary system is described with reference to FIG. 3.

As shown, a plurality of similar notifying devices 6a and 6b, which are commercially available, are disposed at a plurality of prescribed locations.

A condition is set to the digital image forming apparatus so that status information is transmitted to each of the notifying devices 6a and 6b. Thus, user-friendliness can be more improved in transmitting the status information.

As mentioned above, because the notifying device 6a or 6b notifies an error occurred in the digital multi function machine 1, a user can recognize the error without approaching thereof. Thus, completion of a job is not necessarily waited beside the digital multi function machine 1.

Further, a printing job is not excessively requested, thereby a serious load on a server is avoided.

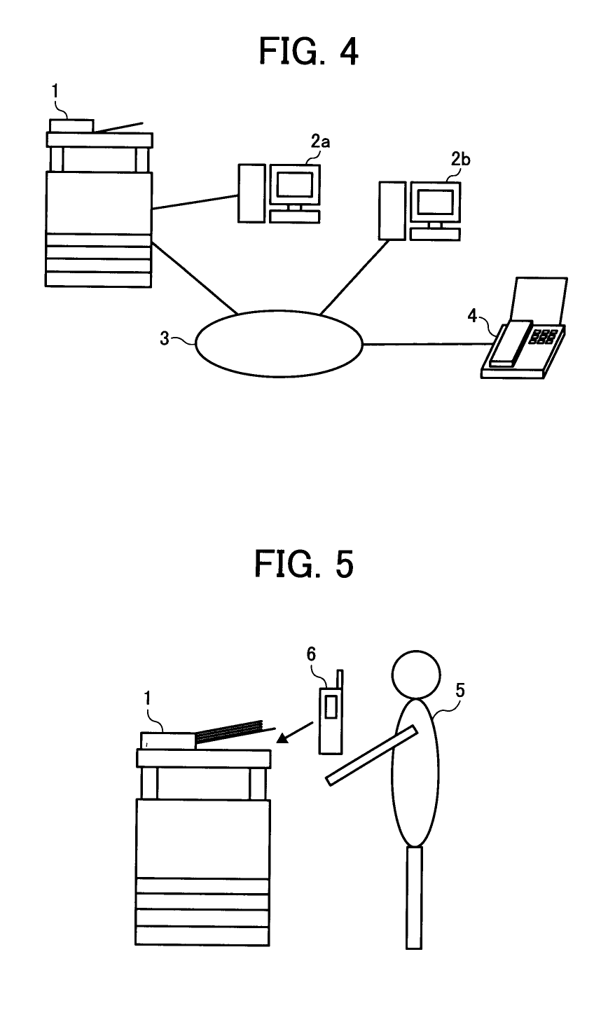

In one embodiment, a digital multi function machine 1 includes multiple functions of a printer, a copier, a scanner, and a facsimile or the like as shown FIG. 4.

Thus, a user 5 operates the digital multi function machine 1 and makes copies from original documents as shown in FIG. 5. Specifically, the user 5 initially sets original documents to the digital multi function machine 1.

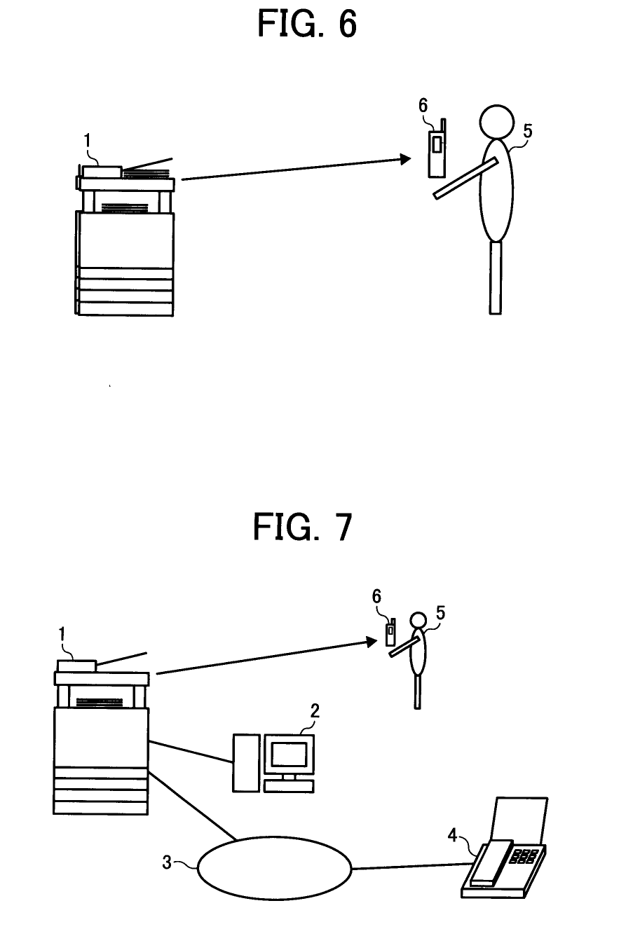

Then, the user 5 designates a destination to be notified of completion of copying before depressing a copy bottom, not shown, as shown in FIG. 6.

When either copying is completed or an error occurs during the copying, such status information is transmitted either directly or indirectly, via a server connected to the network as shown in FIG. 3, to the notifying device 6 kept by the user 5. Thus, the user 5 can recognize a progress of the copying even if he or she is apart from the digital multi function machine 1.

Thus, labor of approaching and confirming completion of a job each time can be reduced.

Thus, deterioration of workability, which is caused by absence of an output due to the error, can substantially be avoided. It is also avoided to leave a copy on a tray.

Then, in order to clarify accounting destinations or keep security, a user 5 capable of using the digital multi function machine 1 is restricted. Specifically, only a registered user 5 can operate various functions of the digital multi function machine 1 by obtaining personal authentication.

Further, a digital multi function machine 1 previously includes registrations of notification destinations (e.g. mobile phones) of all members, and provides authentications for applicable users 5 who requests for using the digital multi function machine 1 and are already registered.

Simultaneously, the digital multi function machine 1 determines the notification destinations of the applicable users 5. Thus, workability increases more.

Instead of storing the notification destinations as mentioned heretofore, the digital multi function machine 1 can read such registrations stored in a server that administrates user information.

Such user information can efficiently be used especially when a plurality of the digital multi function machines 1 is employed. That is, registered user information is not necessarily maintained in each of the digital image forming apparatuses, and only user information is sufficiently maintained in the server.

Further, the digital multi function machine 1 may be inhibited to be used unless authentication information is acquired from an applicable mobile instrument.

When the authentication information is read from the mobile instrument, the digital multi function machine can be operated and a notification destination is set, simultaneously. Thus, user-friendliness remarkably increases due to omission of labor.

In executing authentication, various manners are employed. For example, a number of a mobile instrument is inputted. Infrared light is communicated from a mobile instrument. Non-contact communication is executed using a wireless IC chip. Further, a code reading apparatus or a camera is installed in a digital multi function machine 1 and bar code information is displayed on the mobile instrument.

Authentication using the non-contact communication by means of a wireless IC chip is significantly simple and user friendly, because authentication is executed by simply holding up the wireless IC chip.

Further, when the digital multi function machine 1 is commonly used by a plurality of groups and information of mobile instrument belonging to the group is stored in an IC chip of the mobile instrument, a group is more readily recognized as an accounting destination.

An exemplary system in which a digital multi function machine 1 is connected to a network is illustrated in FIG. 7.

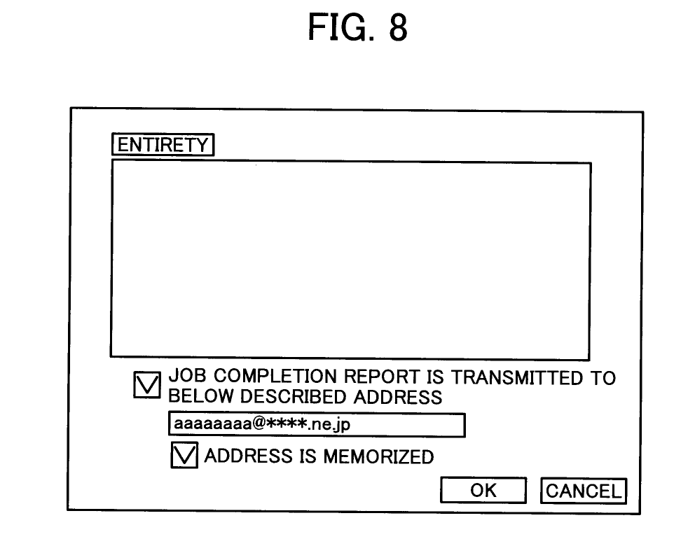

An exemplary screen in which a printing instruction is described is illustrated in FIG. 8.

The above-mentioned systems are preferably used when facsimile transmission, direct image printing from a digital camera, and various actions via an operation section such as scan-to-mail are executed in the digital multi function machine 1 connected to the network as shown in FIG. 7.

Further, when a printer function is implemented, the end of printing can be notified to a mobile instrument by designating a notification destination when a print instruction is provided to a digital multi function machine 1 in FIG. 8. A destination is not necessarily inputted each time, if a check box is provided and is checked to memorize a notification destination.

Now, an exemplary operation when a facsimile is received is described.

Since facsimile reception is passive, a recipient is rarely aware of the reception. Especially when the digital multi function machine 1 ejects a sheet into a space between a scammer and a printer (i.e., inside), the sheet is hardly observed and the facsimile reception is hardly perceived.

Then, such reception is notified either to a personal mobile instrument or a representative mobile instrument for several persons when the digital multi function machine 1 is used personally or shared by the several persons. Thus, such facsimile reception can be credibly recognized.

Further, in one embodiment, if an operational condition is set to the digital multi function machine 1 to enable the digital multi function machine 1 to transfer notification information to the next mobile instrument when the notification to the representative mobile instrument results in failure due to bad environment for electric wave or malfunction of the representative mobile instrument, absence of the notification of facsimile reception can substantially be avoided.

Further, in another embodiment, a sender preferably transmits a facsimile while clearly identifying a destination thereof. Thus, a reception side apparatus can quickly determine the destination even when a large number of persons commonly use the digital multi function machine 1, thereby facsimile reception can be accurately and quickly notified to the mobile instrument of the destination.

Thus, the mobile instrument preferably includes at least an information communication function, such as a mail function, etc.

Such a mobile instrument can be a mobile phone supplied by a company or that of private use already registered as far as being capable of receiving the above-mentioned transmission. Since such a mobile instrument can be used based on an existing infrastructure, introduction cost can be reduced.

Further, a facsimile is credibly outputted and loss of the output can be significantly reduced, because a recipient selects and depresses a facsimile reception item on an operation section of the digital multi function machine 1.

Further, security is improved when authentication certifying a recipient of a facsimile is adopted before the facsimile is outputted.

Further, the digital multi function machine 1 may be controlled to transmit authentication information assigned to a facsimile to a recipient along with notification of reception of the facsimile.

Then, the facsimile can be outputted when authentication is executed by the recipient using the authentication information. Thus, security of facsimile information, and user-friendliness needed in selecting a facsimile among plural facsimiles are improved.

Further, when a recipient is impossible to directly receive a facsimile, the facsimile is transferred to a trustworthy third person instead of the recipient.

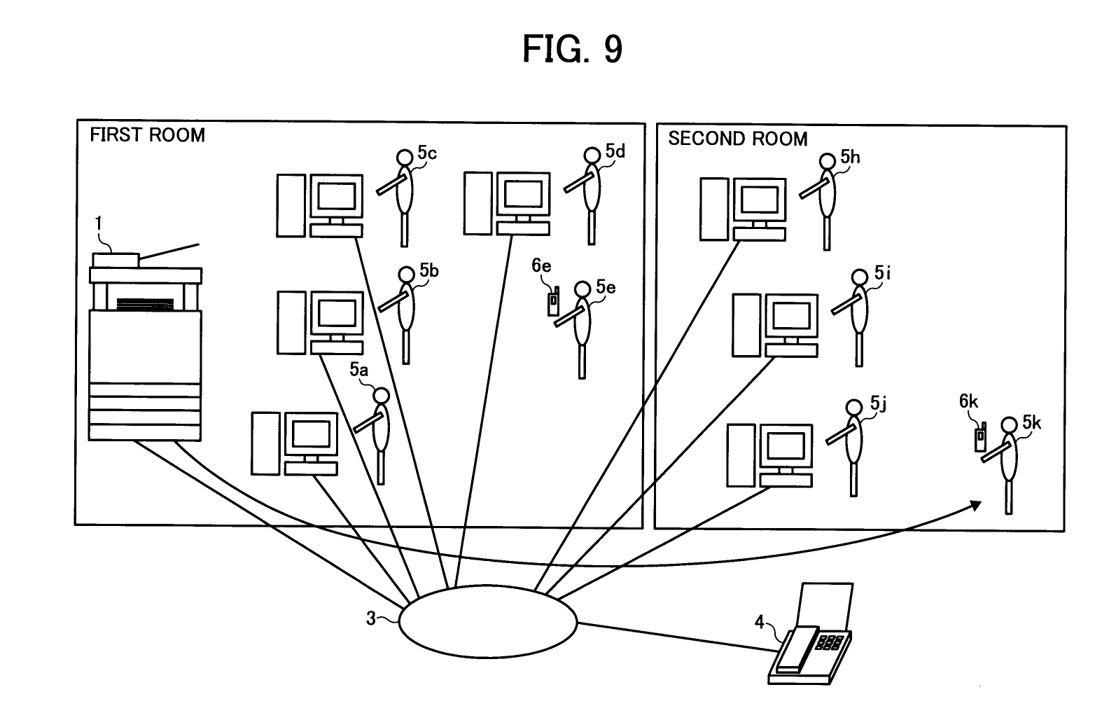

Thus, a flexible facsimile function capable of transferring a facsimile to a substitute recipient determined by a recipient can be provided while a high security performance is maintained. By using these functions, a facsimile function can be shared without leaking facsimile information even when a facsimile function added digital multi function machine 1 is shared by plural groups as shown in FIG. 9.

As an authentication device, various systems are employed. For example, inputting a number of a mobile instrument, infrared light communications from a mobile instrument, non contact communication using a wireless IC chip, and information communication by arranging either a code reading apparatus or a camera in the digital multi function machine 1 and displaying bar code information on a mobile apparatus or the like are exemplified.

Among them, the non-contact communications using wireless IC chip information is most preferably employed, because authentication is significantly simply and user friendly executed by holding up a mobile instrument.

When the digital multi function machine 1 is used by a plurality of groups while group information of mobile instruments belonging the group are registered in an IC chip of the mobile instrument, an accounting destination group is more efficiently identified.

Further, when a transmission document (a facsimile) is outputted based on an additional action or through authentication of a recipient, there exist some time periods before the outputting the transmission document after start of transmission of the transmission document from a sender.

Then, when completion of facsimile transmission is notified to a mobile instrument as a destination of the transmission document, and the destination recognizes that the destination is erroneous during the time period, the destination transmits cancellation instruction to a digital multi function machine 1 of the erroneous destination to inhibit outputting the transmission document during the time period.

Thus, transmission error can be quickly responded while avoiding needless leakage of the facsimile information.

Further, information transmitted to a mobile instrument from a digital multi function machine 1 as a reception apparatus preferably includes information specifying the digital multi function machine 1 together with a facsimile document received by the digital multi function machine 1.

Accordingly, even when he or she is remote from digital multi function machine 1, or when the digital multi function machine 1 is impossible to output a facsimile, he or she can request the digital multi function machine 1 to transfer the facsimile to another facsimile reception available digital multi function machine 1 by specifying the other facsimile reception available digital multi function machine 1 along with the facsimile document.

Thus, since a digital multi function machine 1 other than a facsimile reception digital multi function machine 1 can output a reception facsimile, communications of facsimile information can be user-friendly.

Obviously, numerous additional modifications and variations of the present invention are possible in light of the above teachings. It is therefore to be understood that within the scope of the appended claims, the present invention may be practiced otherwise than as specifically described herein.

What is claimed is:

1. An image forming apparatus for forming an image based on an instruction provided by one of an external image forming apparatus connected to the image forming apparatus via a network and an operation section of the image forming apparatus, said image forming apparatus comprising:
a detecting device configured to detect a job progressing status in the image forming apparatus;
a transmission device configured to receive from the detecting device and transmit the information of the job progressing status; and
an information notifying device configured to receive from the transmission device and notify a user of the job progressing status;
wherein said information notifying device is detachable from the image forming apparatus.

2. The image forming apparatus as claimed in claim 1, wherein said information notifying device executes the notification using light emission.

3. The image forming apparatus as claimed in claim 1, wherein said information notifying device executes the notification using buzzer.

4. The image forming apparatus as claimed in claim 1, wherein said information of the job progressing status is transmitted to the information notifying device via one of a wired cable and a server computer.

5. The image forming apparatus as claimed in claim 1, wherein said information of the job progressing status is wirelessly transmitted to the information notifying device.

6. The image forming apparatus as claimed in claim 1, wherein said job progressing status relates to completion of copying.

7. The image forming apparatus as claimed in claim 1, wherein said job progressing status relates to reception of a facsimile.

8. The image forming apparatus as claimed in claim 7, wherein said information notifying device stops the notification when receiving a signal representing removal of the facsimile from the image forming apparatus.

9. The image forming apparatus as claimed in claim 1, wherein said notification device notifies a user of an error occurred in the image forming apparatus.

10. The image forming apparatus as claimed in claim 1, wherein said notification device includes a mobile instrument, and wherein a facsimile transmission completion report is transmitted from the external image forming apparatus to the mobile instrument of a recipient of the facsimile together with facsimile information when the external image forming apparatus sends the facsimile to the image forming apparatus.

11. The image forming apparatus as claimed in claim 10, wherein said image forming apparatus starts image formation for the first time upon receiving an instruction for start copying from the mobile instrument.

12. The image forming apparatus as claimed in claim 10, wherein information necessary for authorization is transmitted to the mobile instrument, and wherein said image forming apparatus starts image formation for the first time when the user uses the authorization information and is authorized.

13. The image forming apparatus as claimed in claim 10, wherein said image forming apparatus receives an instruction for canceling an output of the facsimile from the mobile instrument when mobile instrument is erroneously regarded as a recipient by the external image forming apparatus.

14. The image forming apparatus as claimed in claim 10, wherein information specifying a still another image forming apparatus coupled to the network as a recipient is transmitted to the image forming apparatus from the mobile instrument, and wherein said facsimile is transferred to the other image forming apparatus.

15. The image forming apparatus as claimed in claim 1, wherein said information includes codes to be read by a code reader.
